(19) United States
(12) Patent Application Publication
(10) Pub. No.: US 2010/0231161 A1
(43) Pub. Date: Sep. 16, 2010

(54) Apparatus for Storing and Charging Electronic Devices

(76) Inventor: Wendell Brown, Henderson, NV (US)

Correspondence Address: PARK, VAUGHAN & FLEMING LLP, 2820 FIFTH STREET, DAVIS, CA, 95618, US

(21) Appl. No.: 12/427,712

(22) Filed: Apr. 21, 2009

Related U.S. Application Data
(60) Provisional application No. 61/159,670, filed on Mar. 12, 2009.

(51) Int. Cl. H02J 7/00

(52) U.S. Cl. 320/101; 320/107

(57) ABSTRACT

An apparatus is provided for conveying and charging portable electronic devices. The apparatus comprises internal and/or external electrical interfaces (e.g., 120 volt AC, 12 volt DC, USB) electrically coupled to an adapter for plugging into an external power source (e.g., 120 volt AC). Devices coupled to the interfaces are charged while the apparatus is coupled to the external power. The apparatus may also comprise one or more batteries for storing electrical power and charging one or more devices even while the apparatus is not coupled to an external power source. The apparatus may be configured as a briefcase, a purse, a suitcase or other portable container, and may comprise handles and/or wheels to improve its mobility.

### RELATED APPLICATION

This application claims priority to U.S. Provisional Application No. 61/159,670, filed Mar. 12, 2009, which is hereby incorporated by reference.

### BACKGROUND

This invention relates to the field of electronics. More particularly, a portable carrying case is provided that is capable of charging electronic devices placed in the case.

Electronic devices such as mobile telephones, portable digital assistants (PDAs), laptop computers, portable game units, music players and others require regular recharging. Charging them can often be inconvenient, especially for a user who totes multiple devices. He or she may need to transport several chargers, transformers, cables, cradles and/or other equipment, and regularly set them up to be charged, and then dismantle the arrangement when charging is complete.

For example, a traveler who stays overnight in different locations may have developed a nightly routine of unpacking all of his devices and their charging apparatuses, and setting them all up to recharge. In the morning, after they have recharged, he must repack everything before commencing the day's travel and repeating the process that evening.

If a user forgets to charge a particular device, he may be unable to use it for most or all of the day if he does not have access to a 120 volt AC outlet. A device that is used heavily during a day, or that has a battery that is deteriorating and cannot hold its charge for as long as it used to, may also be out of commission before the user can recharge it.

One solution to this problem is to carry multiple batteries for the devices, and though this may extend one's ability to use the devices, it may also compound the overall problem. To have use of the extra batteries, they also must be recharged. Because recharging equipment is identical for very few devices, a person would need to either transport additional charging equipment to recharge all batteries simultaneously, or rotate use of each device's charger among the device's multiple batteries.

### SUMMARY

In one embodiment of the invention, an apparatus is provided for conveying and charging portable electronic devices. The apparatus comprises internal and/or external electrical interfaces electrically coupled to an adapter for plugging into an external power source (e.g., 120 volt AC). The interfaces may include USB outlets, 12 volt DC outlets, 120 volt AC outlets and/or others now known or hereafter developed.

Devices coupled to the interfaces are charged while the apparatus is coupled to the external power. The apparatus may also comprise one or more batteries for storing electrical power and charging one or more devices even while the apparatus is not coupled to an external power source. The apparatus may be configured as a briefcase, a purse, a suitcase or other portable container, and may comprise handles and/or wheels to improve its mobility.

The apparatus may comprise a number of compartments, shelves, or other means for dividing its interior space. For example, the electrical interfaces and batteries may be located in a bottom or rear area, and devices may be placed in one or more different compartments easily accessible to a user. Wire guides may be incorporated into the apparatus, or wires may run freely between compartments to connect the interfaces to cradles, docking stations or other charging equipment.

### DESCRIPTION OF THE FIGURES

FIG. 1 is a diagram of an apparatus for simultaneously storing and charging one or more electronic devices, according to some embodiments of the invention.

FIG. 2 is a diagram of another apparatus for simultaneously storing and charging one or more electronic devices, according to some embodiments of the invention.

FIG. 3 is a diagram of yet another apparatus for simultaneously storing and charging one or more electronic devices, according to some embodiments of the invention.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the scope of the present invention. Thus, the present invention is not intended to be limited to the embodiments shown, but is to be accorded the widest scope consistent with the principles and features disclosed herein.

In embodiments of the invention described herein, apparatuses are provided for carrying as well as charging one or more electronic devices. The apparatus, which may serve as a purse, briefcase, carry-on bag or other conveyance (e.g., a “wheelie”) in different implementations, includes means for distributing electrical power to the devices. The devices may include portable computers and/or computing equipment, personal digital assistants, telephones, calculators, games, etc.

In these embodiments, transformers, cradles or other equipment for charging the devices may be permanently (or semi-permanently) plugged into outlets or electrical interfaces arranged within the apparatus. When the apparatus is plugged into an external power source (e.g., in a hotel, in an office, in a conference room), power is automatically supplied to the charging equipment to charge any devices connected to the equipment. A user may use his or her device(s) as needed and place them in the apparatus to charge when not in use.

The apparatus may comprise multiple compartments, internal and/or external to the apparatus. One or more devices may be placed in each compartment for charging. Equipment for charging each such device (e.g., a cradle, a transformer) may be placed in the same compartment, a different compartment, or may be built into the apparatus/compartment.

Because different devices may have different interfaces for receiving electrical power for recharging, the apparatus may comprise outlets or interfaces for regular 120 volt AC wall outlets, 12 volt cigarette-style outlets, USB (Universal Serial Bus) ports, and/or other interfaces now known or hereafter developed.

In some embodiments of the invention, the apparatus may also include storage means (e.g., battery, fuel cell) for receiving and storing electrical energy while the apparatus is connected to an external power source. When the apparatus is disconnected from the power source, electrical energy stored in the storage means may be used to charge the user's devices.

The apparatus may also have external power outlets (e.g., 120 volt AC, 12 volt, USB) that are powered when the apparatus is plugged into an external electrical power source. These outlets may or may be powered by internal storage means when the apparatus is disconnected from the external power source.

In different embodiments, the apparatus may comprise one or more handles, which may or may not be retractable, two or more wheels, one or more vents and/or one or more fans for dissipating heat. An apparatus may also include other features of luggage, purses and other types of bags, such as pockets, flaps, zippers, snaps, ties, etc.

The apparatus may also include circuitry for distributing, conditioning or otherwise manipulating electrical energy. Such components may include one or more of the following: a rectifier to convert AC electrical power to DC, an inverter to convert DC electrical power to AC, a transformer for producing electrical power at a particular voltage, and so on. These components may be built into the apparatus, or may be removable.

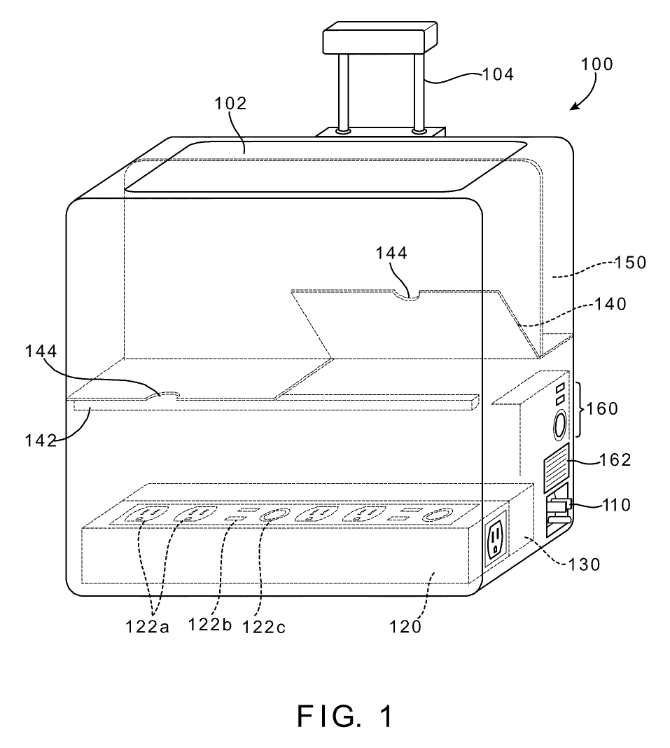

FIG. 1 is a diagram of an apparatus for simultaneously storing and charging one or more electronic devices, according to some embodiments of the invention.

Apparatus 100 of FIG. 1 is generally rectangular in shape, with at least one side, such as top 102, containing an aperture that can be opened to gain access to the interior. More than one side may provide openings into the apparatus, and an aperture may comprise a full side, or a portion of a side of the apparatus. Although not shown in FIG. 1, the apparatus may also include any number of pockets, flaps or other relatively small or thin compartments for storing paper, writing implements, books, accessing a compartment, etc.

Apparatus 100 includes retractable handle 104 which, in conjunction with wheels 106, allow the apparatus to be easily transported. The apparatus may also, or instead, include a fixed handle and/or straps or other means to allow it to be carried instead of wheeled. In other embodiments of the invention, the apparatus may be smaller or larger, and/or of different shape, in which case handle 104 and/or wheels 106 may be omitted or supplemented.

Retractable electrical plug 110 allows the apparatus to be plugged into an external power source (e.g. a 120 volt AC wall outlet). In some implementations, plug 110 may not be retractable, and in other implementations multiple external plugs may be provided.

When the apparatus is plugged into an external power source, power is automatically supplied to power strip 120, which may host any number and type of power outlets 122. As shown in FIG. 1, the power strip includes traditional 120 volt AC outlets 122a, USB (Universal Serial Bus) interfaces 122b and 12 volt DC outlet 122c. Power strip 120 may be enhanced with surge suppression, line conditioning, an on/off control and/or other features. For example, if the apparatus includes one or more batteries, then one or more of outlets 122 may also be enhanced with UPS (Uninterruptible Power Supply) capability.

In some embodiments of the invention, power strip 120 is fully integrated into the apparatus, in which case only outlets 122 may be visible within the apparatus. In other embodiments the power strip may be removable or replaceable, in which case the entire strip may be visible or accessible.

Above power strip 120 are one or more folding shelves 140 that can be folded upward (or downward) to gain access to power strip 120 (e.g., to plug something in or to unplug something). Support(s) 142 may be employed to support a shelf 140 when in a horizontal orientation. A folding shelf may also include one or more cutouts 144 to allow wires/cables to run between the lower compartment (where power strip 120 resides) and an upper compartment where electronic devices may be stored.

Thus, in FIG. 1, equipment for charging an electronic device may be plugged into an outlet 122 of power strip 120, and wires may be run as needed to an upper compartment where the device may be place for easy access by a user. Charging equipment may be stored in either or both a lower and upper compartment. For example, a transformer may be left in the lower compartment, while a device cradle may be placed in the upper compartment.

Hooks, snaps, tethers or other means may be incorporated into the apparatus to hold wires and/or other charging equipment. For example, wires may be run along a series of such means affixed to interior walls of the apparatus, to keep them out of the way and the help keep it tidy.

Also as shown in FIG. 1, apparatus 100 may include battery 130 for storing electrical energy received via external plug 110. Although a single battery is identified in the figure, in other embodiments of the invention multiple batteries may be implemented to work together, and may be located at the bottom of the apparatus (as in FIG. 1) and/or on its sides, particularly a rear side to help with proper distribution of weight and allow easy wheeling.

FIG. 1 also shows an optional laptop computer compartment 150. Illustratively, a laptop computer may be placed in the compartment with its power interface port facing upward or downward, and a user may connect its recharging equipment in either orientation. An aperture for accessing laptop compartment 150 may be collocated with an aperture in top 102, or may comprise a separate aperture in the top, rear or other side of the apparatus.

In some embodiments of the invention, apparatus 100 also includes external power outlets 160, which are supplied with power when external plug 110 is connected to an external power source. Outlets 160 may also be powered (from battery 130) when no external power source is coupled to the apparatus.

Vent(s) 162, which may be augmented (or replaced) with one or more fans, allow dissipation of heat generated within apparatus 100. Although vent 162 is only shown on one side of the apparatus, in other embodiments of the invention additional vents may be integrated into the design.

In some alternative embodiments of the invention, one or more sides may be fully or partially composed of a mesh or mesh-like material to allow even greater air circulation. A partial or full mesh side may be coverable when the air circulation is not needed. For example, a liner may zip up or snap on to cover the meshed area.

An apparatus such as apparatus 100 may optionally include two or more wheels to facilitate its transportation. In some embodiments of the invention, one or more wheels may comprise generators capable of generating electrical energy when the wheels are engaged. The generated energy may be used to power some subset of the internal and/or external outlets and interfaces, and/or may be used to charge battery 130.

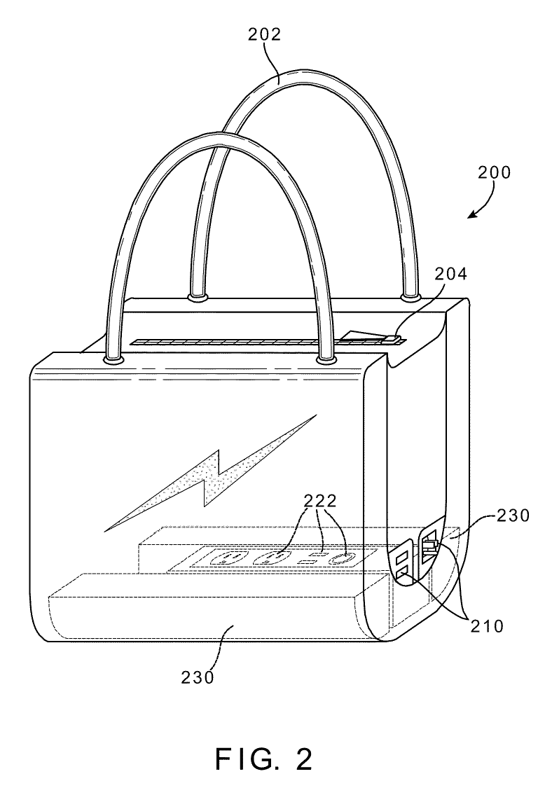

FIG. 2 is a perspective view of another apparatus for carrying and charging electronic devices, according to some embodiments of the invention.

In these embodiments, apparatus 200 is designed to be used as a purse or satchel. Handles/straps 202 may be configured for hand use (i.e., carrying the apparatus by hand), or for over-the-shoulder wearing, depending on the length of the straps, the size of the loops, etc. Zipper 204 or other means (e.g., snaps, magnets, ties, cords) may be used to close and open the apparatus.

External plugs 210, which may or may not be retractable, allow apparatus 200 to be connected to an external power source (e.g., 120 volt AC wall outlet, a USB port on a computer). Any number and type of external plugs may be embodied in an apparatus in different embodiments of the invention. If the plugs are not integrated with retractable cords, then extension cords may be provided, and may be stored in the apparatus when not in use. Plugs 210 may be covered or coverable, such as with flaps that zip or snap closed.

Although two external USB plugs are shown in FIG. 2, in some embodiments, one may be used to connect to a powered USB interface (e.g., of a computer or powered USB hub), while one or more others may be used to connect/recharge a device having a USB port. Thus, when apparatus 200 is coupled to external power (by a USB or other plug), the apparatus may be able to act as a powered USB hub.

In embodiments of the invention in which an external plug is configured to plug the apparatus into an electrical power source providing something other than 120 volt AC power (e.g., USB, 12 volt DC), not all internal/external power interfaces of the apparatus may be powered. For example, when a retractable plug 210 of FIG. 2 is used to plug apparatus 200 into a powered USB port of a computer, USB hub or other equipment, power may only be delivered to USB-type interfaces of apparatus 200.

Apparatus 200 includes one or more internal power outlets 222 for mating with charging equipment of one or more electronic devices. As with the embodiments of the invention illustrated in FIG. 1, any number and type of sockets may be implemented. One or more external outlets may also be provided, of any type.

Batteries 230 are integrated into sides/bottom of apparatus 200, and store electrical energy for later charging/recharging of electronic devices when no plug 210 is coupled to an external power source. The batteries may work cooperatively or separately, and in other embodiments of the invention a different number of batteries may be provided (i.e., 0 or more).

The various electrical components/elements of apparatus 200 may be arranged or arrayed in a manner that evenly or fairly evenly distributes their weight within the apparatus. Thus, multiple batteries may be placed on opposing sides, a single battery may be placed on the bottom, and so on.

In an embodiment of the invention in which an apparatus for carrying and charging electrical devices is relatively small (e.g., such as a purse, clutch bag or fanny pack), a power strip may be omitted. In such an embodiment, when a (e.g., retractable) plug is connected to an external power source, power may be distributed to just one or a limited number of internal interfaces (e.g., one 120 volt AC outlet, one USB interface). This allows the apparatus to be kept small.

In some embodiments of the invention, one or more surfaces of an apparatus for carrying and charging electrical devices may comprise photovoltaic material for converting light into electrical power. The generated electricity may be used to power one or more internal or external electrical interfaces, and/or to charge a battery. The photovoltaic material may be extendable (e.g., fold-out) to capture additional light.

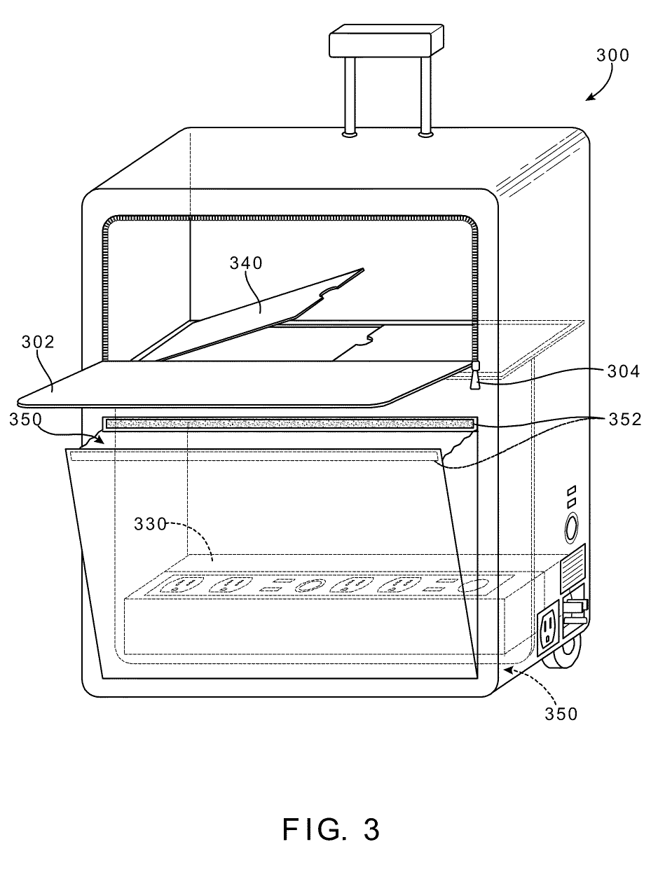

FIG. 3 is a perspective view of yet another apparatus for carrying and charging electronic devices, according to some embodiments of the invention.

In these embodiments, apparatus 300 comprises a partially foldable front side, wherein flap 302 can be unzipped with zipper 304 (or other means of opening and closing an aperture). Opening flap 302 gives a user access to the inside of the apparatus, to place his devices and their charging equipment, route wiring as necessary, etc. In different implementations, zipper 304 may be configured differently, such as by being located at the edges of the front (or other side) of apparatus 300, so that it may be opened like a suitcase.

Apparatus 300 also incorporates a re-sealable aperture for accessing laptop compartment 350. The aperture may be sealed by zipper 352 and/or other means. This location of the laptop compartment allows a user quick access to the laptop when needed. Note that the laptop compartment may also be accessible via the aperture created when flap 302 is opened. Or, the laptop compartment may have only a single opening defined by zipper 304.

As with previously described embodiments of the invention, apparatus 300 includes one or more batteries 330, a power strip with any number and type of internal power outlets, an external plug for connecting to an external power source, vents/fans, and one or more external power outlets. Apparatus 300 also includes one or more foldable shelves 340, which illustratively open at right angles to flap 502. This allows a user to easily access the full interior area of the apparatus.

In some embodiments of the invention, an electronic device may be charged or recharged inductively rather than conductively. In these embodiments, an apparatus incorporates one or more inductive coils or windings, or a component comprising such coils/windings may be placed within or installed in the apparatus. A user may then simply place his or her inductively chargeable device on, beside or in proximity to the inductive charger, without plugging it in.

It has been noted that apparatuses described herein are configured to not only convey one or more electronic devices, but to also charge/recharge them. The charging may occur while the apparatus is relatively stationary (e.g., while plugged into a 120 volt wall outlet or a computer's USB port), but may also be performed while the apparatus (and the devices) are in motion (i.e., if the apparatus includes a battery or other power storage means).

Yet further, the apparatus also serves to protect the electronic devices placed within it. In particular, devices placed in the apparatus are less likely to be dropped onto the ground or other hard surface, and are less likely to be scratched or otherwise marred. Interior walls, compartments or other surfaces of the apparatus may be padded or constructed (partially or completely) of material unlikely to damage electronic devices (e.g., rubber, cloth, pliable plastic). For example, partitions may be movable (e.g., using Velcro edges) to snugly secure charging equipment and/or devices while still allowing a user ready access.

In addition, the apparatus is sufficiently rigid overall to support the weight of the electrical circuitry, electronic devices stored within, charging equipment for charging the devices and/or other material (e.g., books, papers, clothes).

The foregoing descriptions of embodiments of the invention have been presented for purposes of illustration and description only. They are not intended to be exhaustive or to limit the invention to the forms disclosed. Accordingly, many modifications and variations will be apparent to practitioners skilled in the art. The scope of the invention is defined by the appended claims, not the preceding disclosure.

What is claimed is:

1. An apparatus for transporting and charging one or more electronic devices, the apparatus comprising:
multiple surfaces joined to form a closed but openable container;
a first external electrical adapter configured to electrically couple the apparatus to an external source of electrical power;
a set of internal electrical interfaces configured to receive electrical interfaces of one or more portable electronic devices; and
at least one handle.

2. The apparatus of claim 1, wherein said first external electrical adapter is electrically coupled to the one or more internal electrical interfaces so as to permit the portable electronic devices to be charged while the apparatus is electrically coupled to the external source of electrical power.

3. The apparatus of claim 1, further comprising one or more batteries; wherein the one or more batteries are configured to be charged while the apparatus is electrically coupled to the external source of electrical power.

4. The apparatus of claim 1, wherein at least a portion of one surface of the multiple surfaces is transitionable between an open position and a closed position.

5. The apparatus of claim 1, further comprising two or more wheels.

6. The apparatus of claim 5, wherein at least one of the two or more wheels comprises an electrical generator configured to generate electrical energy as the apparatus is transported on the two or more wheels.

7. The apparatus of claim 1, further comprising:
a first internal compartment; and
a second internal compartment separated from the first internal compartment by one or more foldable partitions.

8. The apparatus of claim 7, wherein the second internal compartment comprises said one or more internal electrical interfaces.

9. The apparatus of claim 7, wherein the first internal compartment is configured to accommodate the portable electronic devices.

10. The apparatus of claim 1, wherein one or more of the multiple surfaces comprise photovoltaic material for converting light into electrical energy.

11. The apparatus of claim 1, further comprising one or more external electrical interfaces electrically coupled to the first external electrical adapter.

12. The apparatus of claim 11, wherein the external electrical interfaces and the internal electrical interfaces include one or more of:
a 120 volt AC outlet;
a 12 volt DC outlet; and
a USB port.

13. A portable apparatus for transporting, protecting and facilitating charging of one or more electronic devices, the apparatus comprising:
multiple surfaces joined to form a container that is openable through at least one aperture;
a set of electrical interfaces configured to supply electrical energy to devices plugged into the electrical interfaces;
a battery configured to store electrical energy; and
means for distributing electrical energy received from an external source to the set of electrical interfaces;
wherein at least one of the multiple surfaces comprises a photovoltaic material capable of converting light into electrical energy.
